(19) United States
(12) Patent Application Publication
(10) Pub. No.: US 2016/0301675 A1
(43) Pub. Date: Oct. 13, 2016

(54) SYSTEM FOR AUTHENTICATING MULTIPLE USERS

(71) Applicants: Charles Wiles, Guildford Surrey (GB); Edward Wiles, Harpenden, Hertfordshire (GB); Samir Seetal, West Drayton (GB)

(72) Inventors: Charles Wiles, Guildford Surrey (GB); Edward Wiles, Harpenden, Hertfordshire (GB); Samir Seetal, West Drayton (GB)

(73) Assignee: Zzish Ltd, Guildford (GB)

(21) Appl. No.: 15/038,646

(22) PCT Filed: Nov. 21, 2014
(86) PCT No.: PCT/GB2014/053457

§ 371 Date: May 23, 2016

(30) Foreign Application Priority Data
Nov. 22, 2013 (GB) 1320687.5

(51) Int. Cl. H04L 29/06; A63F 13/73; A63F 13/35

(52) U.S. Cl. CPC H04L 63/08; H04L 63/105; A63F 13/35; A63F 13/73

(57) ABSTRACT

Disclosed is a method of registering users in a software system for participation in a multi-user activity. The method involves receiving authentication information for a first user from a client device, and authenticating the first user based on the authentication information. In response to successful authentication of the first user, a user group associated with the first user is identified, the user group comprising a plurality of further users. User identifiers for the further users are transmitted to the client device. A selection of one or more of the further users is then received from the client device, and the one or more selected further users are registered within the software system as participants in the multi-user activity.

### BACKGROUND

Many software applications require users to authenticate themselves by providing a username and password before the user can use the application. There may be several reasons to require user authentication for an application including ensuring that a user is only permitted to access information to which they should have access, ensuring that the user can only make changes to the system that they are permitted to make and recording activity in the application associated with that user.

In a classroom environment a teacher may want to record the activity of each individual student who uses a software application so that they can measure the performance of the student and see whether the student is improving or having difficulty in a particular area. To achieve this each student must log into the software application and the application can then record activity for each student.

Some software applications allow several users to be authenticated with the application at the same time. For example multiplayer video games may allow several users to log into the software application and then each user may participate in the game, using the same end user device (but typically separate game controller devices), or alternatively using separate end user devices. As a user gains points or other achievements in the game these are recorded against that user.

### SUMMARY

The present invention aims to simplify the process of authentication when multiple users need to be authenticated with a software application on a single end user device, such as a tablet computer, at the same time. It has particular utility in a classroom environment for software applications on tablet devices where, perhaps, four or five students may need to authenticate themselves to a software application so that they can participate in a shared activity on the tablet. In this case there are a number of problems with the normal process of authentication that requires each student to log into the software application in turn. First, it may take some considerable time for each student to log into the software application using up valuable class time. If each student takes one minute to log in to the application then five minutes of a thirty minute lesson could be spent just in the process of authentication. Second, students often forget their usernames and passwords and as a result the process of authenticating five students can end up taking much longer. Indeed the process may take considerable time when there are thirty students or more in a classroom using multiple tablets.

The present invention thus seeks to provide approaches to user authentication that alleviate some of these problems.

Accordingly, in a first aspect of the invention, there is provided a method of authenticating users in a software system, the method comprising: receiving authentication information; and performing an authentication based on the received authentication information; the method further comprising, in the event of (or responsive to) successful authentication: identifying a user group associated with the authentication information, the user group comprising a plurality of users; transmitting user identifiers for the group users to a first client device; receiving a selection of one or more of the group users from the first client device; and registering the one or more selected group users as active users within the software system.

This approach effectively allows a group of users to be authenticated so that they may utilise functions of the software system by way of a single group-based authentication, removing the need for each user of the group to submit individual authentication information. The authentication information is preferably associated with a first user, and the authentication preferably comprises authenticating the first user based on the authentication information. The user group is then preferably associated with the first user. The first user may be a master user for the group or group owner for the group.

The invention may comprise, responsive to successful authentication of the first user, accessing stored information defining a plurality of user groups and group owners associated with user groups; and identifying a user group for which the first user is specified as group owner in the stored information.

Note that identification of a user group and/or access to user group information associated with the user being authenticated may initially be carried out prior to successful authentication (or while authentication is in progress), but user group information (e.g. user identifiers) are preferably only transmitted, and/or user registration is only performed, if authentication was successful. The present disclosure and appended claims should be interpreted accordingly.

Multiple such groups may be identified, and group information may be transmitted to the client device for a selected one, some or all of the groups.

Alternatively, the authentication information may be group authentication information associated with the user group (e.g. directly, rather than via a group owner).

The one or more selected group users are preferably registered as active users without individual authentication of the one or more group users. In other words, users authenticated by way of group-based authentication can access functions in the software system (e.g. participate in multi-user activities) without submitting individual authentication information.

The authentication information is preferably received from the first client device. This allows the group owner to effectively pre-authenticate (or provision) the first client device for subsequent use by the group members.

The registering step may comprise setting an authentication status of a selected group user (or each such user) to indicate that the user may access one or more software functions in the software system (thus, “registering” a user may essentially correspond to “logging in” a user to the software system).

Advantageously, the registering step may comprise assigning a first authentication level to a selected group user, wherein the first authentication level is different from a second authentication level assigned to a user performing full or individual authentication by submitting authentication information. The terms “full” or “individual” authentication preferably refer to a mode of authentication whereby authentication credentials specific to a user are submitted by the user and authenticated. By way of contrast, group authentication involves a group of users (or selected members thereof) being granted access by a single authentication, which may involve group authentication credentials, or individual authentication of a user who is identified as an owner of the group.

The received authentication information is preferably associated with a first user (e.g. group owner), the method comprising, in response to successful authentication of the first user, assigning the second authentication level to the first user. The method preferably includes providing differential access to software functions in the software system and/or at client devices in dependence on users' respective authentication levels, preferably wherein the first authentication level is more restricted than the second authentication level. Providing differential access typically involves providing access to different functionality sets in dependence on whether the user has the first or second authentication level.

Preferably, a user authenticated as part of a group may subsequently/additionally perform individual authentication, for example at the user's instigation or in response to an attempt to access a restricted function. The method may thus comprise, in response to receiving a request to access a restricted software function from a given user authenticated as a group user and/or having the first authentication level (that does not allow access to the restricted software function), sending a request for authentication information to the given user, and preferably providing access to the restricted software function and/or assigning the second authentication level to the given user in response to receiving and successfully authenticating the authentication information from the given user.

The transmitting step preferably comprises transmitting user identifiers for group users to a plurality of client devices; and wherein the receiving step comprises receiving the selection of one or more of the group users from one or more of the plurality of client devices.

The registering step preferably comprises registering the one or more selected users as participants in a multi-user activity. The activity may be an educational activity and/or a game. Preferably, the method comprises receiving information identifying a multi-user activity from the first client device; the registering step comprising registering the one or more selected users as participants in the identified multi-user activity.

The method preferably comprises: receiving, from a second client device, a request to participate in a multi-user activity; determining whether to grant access to users at the second client device to participate in the multi-user activity; and in the event of a positive determination, transmitting a list of group users of the user group to the second client device. This may allow multiple client devices to be authorised (or provisioned) for access by members of the group based on a single group authentication, e.g. performed at one of the client devices or some central device.

The list transmitted to the second client device may exclude group users already registered (e.g. at the first client device) as participants in the multi-user activity. Preferably, the method comprises receiving a selection of one or more group users from the second client device, and registering the selected users as participants in the multi-user activity.

The second client device is preferably not currently authenticated or not associated with a currently authenticated user. Thus, the second device may be provisioned without the group owner having to also authenticate on the second device (though such authentication could additionally be carried out).

The method may comprising identifying a network, preferably a local area network (LAN) or wireless LAN, associated with the multi-user activity, wherein the determination whether to grant access is performed in dependence on whether the second client device is connected to the identified network. Alternatively or additionally, the authentication information may be received from, or the multi-user activity may have been created at, the first client device, and wherein the determination whether to grant access is performed in dependence on whether the second client device is connected to the same network as the first client device, preferably the same LAN or the same wireless LAN. The determination may include comparing a network identifier such as an SSID. In either case, access is preferably granted if the second client device is connected to the same network. In this way, a second device may be authenticated for the group as long as it is on the same network without requiring separate input of authentication credentials.

The request may comprise an activity code corresponding to the multi-user activity, and the determining step may then comprise accessing stored activity information defining one or more previously configured multi-user activities, searching the stored activity information to determine whether the activity code matches a previously configured activity, and granting access to the multi-user activity matching the activity code if a match is identified.

The determination whether to grant access may be made in dependence on an identity of the second client device, preferably wherein access is granted if a device identifier of the second client device matches one of a preconfigured set of authorised devices.

Preferably, the method comprises receiving activity data relating to the multi-user activity from a client device, the activity data associated with a user identifier; determining whether the user identifier corresponds to one of the registered users for the activity; and processing and/or storing the activity data in response to a positive determination, or outputting an error message in response to a negative determination. Activity data is preferably stored in a database and associated in the database with the user identifier.

Authentication information as referred to above preferably comprises one or more authentication credentials, preferably including a username and/or password.

In a further aspect of the invention, there is provided a method of registering users in a software system for participation in a multi-user activity, the method comprising: receiving authentication information for a first user from a client device; and authenticating the first user based on the authentication information; the method further comprising, in the event of (or in response to) successful authentication of the first user: identifying a user group associated with the first user, the user group comprising a plurality of further users; transmitting user identifiers for the further users to the client device; receiving a selection of one or more of the further users from the client device; and registering the one or more selected further users within the software system as participants in the multi-user activity. The method in this aspect may additionally comprise any steps or features of the method set out above.

In a further aspect, there is provided a method of authenticating users at a client device for access to a software service, the method comprising: receiving user input comprising authentication information; and performing an authentication based on the authentication information; the method further comprising, if authentication was successful: obtaining user group information (the user group information preferably associated with the authentication information), the user group information specifying a user group including a plurality of users; outputting a list of users of the group to a user interface; receiving user input indicating a selection of one or more of the group users; and registering the one or more selected group users as active users of the software service.

The step of performing an authentication preferably comprises transmitting the authentication information to the software service; and receiving an authentication response from the software service; preferably wherein the user group information is received from the software service following a successful authentication. The method may comprising determining whether a connection to a network is available; and, if a connection is not available, performing the authentication based on authentication data cached at the client device responsive to a previously performed authentication.

Preferably, if a network connection is not available, the method may comprise obtaining the user group information from locally cached user group information.

Preferably, the method comprises running at the client device a multi-user activity module for participating in multi-user activities, the registering step comprising registering the one or more selected group users as participants in a multi-user activity. The method may comprise providing at the client device a user interface for participation by the one or more selected group users in the multi-user activity, preferably wherein the user interface is arranged for turn-based participation by the users and/or wherein the user interface comprises respective separate user interface elements or regions for interaction by each of the selected group users.

The method may comprise generating activity data in response to inputs received from the one or more selected group users relating to the multi-user activity, and transmitting the activity data to the software service. In response to detecting that a network connection is not available, the method preferably includes caching the activity data at the client device at a first time, and transmitting the activity data at a second time when a network connection is available.

The registering step may comprise transmitting a registration request to the software service to register the one or more selected users at the software service. The transmission may be deferred until a network connection becomes available if not available at the time the user selection is received.

The list of users output to the user interface preferably does not include users already registered as active users or activity participants.

The method may comprise caching authentication information and/or user group information at the client device in response to a successful authentication.

In further aspects, the invention provides a system, device or apparatus (e.g. a client or server device) having means, preferably comprising a processor and associated memory, for performing any method as set out herein.

The invention also provides a computer program or computer program product or tangible/non-transitory computer-readable medium comprising software code adapted, when executed on a data processing apparatus, to perform any method as set out herein.

The invention extends to methods and/or apparatus substantially as herein described with reference to the accompanying drawings.

Any feature in one aspect of the invention may be applied to other aspects of the invention, in any appropriate combination. In particular, method aspects may be applied to apparatus aspects, and vice versa.

Furthermore, features implemented in hardware may generally be implemented in software, and vice versa. Any reference to software and hardware features herein should be construed accordingly.

Preferred features of the present invention will now be described, purely by way of example, with reference to the accompanying drawings, in which:—

### BRIEF DESCRIPTION OF THE DRAWINGS

FIG. 1 illustrates a multi-user computer system in overview;

FIG. 2 illustrates a server providing authentication and user data processing functionality;

FIG. 3 illustrates a process for user authentication;

FIG. 4 illustrates processing of user data;

FIGS. 5 and 6 illustrate further configurations of the multi-user computer system; and

FIG. 7 illustrates client and server devices for use in the multi-user computer system.

### DETAILED DESCRIPTION

Embodiments of the invention provide systems and methods for simplifying authentication of multiple users in a software application.

In particular disclosed embodiments, the users are participants in multi-user educational activities, in particular multiplayer educational games and quizzes. However, the disclosed principles may be applied in other contexts, such as other forms of multi-user collaboration, e.g. videoconferencing, virtual meeting rooms, and the like.

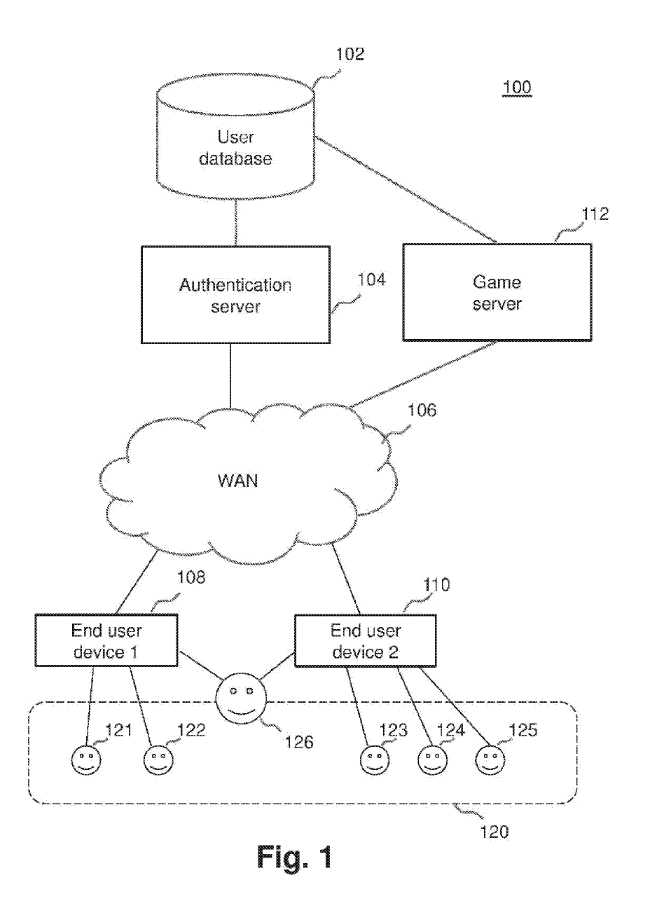

A multi-user computer system is illustrated in overview in FIG. 1.

The system includes multiple end user devices 108, 110, connected via a network 106 to an authentication server 104 and a game server 112.

Users participate in multiplayer activities using the end user devices 108, 110. The end user devices may be any form of network-connectable computing devices and in preferred embodiments are tablet computers with touch screen displays.

A particular multiplayer activity or game may have multiple participants on different end user devices. Furthermore, multiple users may participate at the same user device, for example by taking turns or by using separate areas on the tablet touch screen display.

An authentication server 104 provides for authentication of the users participating in activities, whilst a game server 112 manages the activities themselves, collecting user inputs and game outcomes, maintaining leader boards, and the like. The game server may also provide analytics functionality for evaluating performance of users in individual activities or over multiple activities, e.g. to measure learning improvements. A database 102 stores user and authentication data, as well as game-related data.

Users may log in to the system either as individuals, or as members of predefined user groups. When logging in as group member, authentication is simplified. Each group of users is associated with a group owner, who is the master user for that group, and who may perform authentication on behalf of members of the group.

As a result, the system provides for multiple possible levels of authentication for a given user:
not logged in,
logged in as member of a pre-authenticated group,
logged in as an individual user

Different permissions may be associated with different authentication levels. For example, the actions available to a user authenticated as a group member may be different from those available to an individually authenticated user (and different again from those available to an unauthenticated user).

Group login involves the group owner (master user for the group) logging in on a given end user device using authentication credentials such as a username and password. If the group owner is authenticated successfully, then a list of group members is transmitted to the device. Later (e.g. prior to starting an activity), the list of group members is displayed. Individual users then log in and join the activity simply by selecting their name from the displayed list, without the need to provide full authentication credentials (e.g. username and password). Multiple group members may use the same end user device. Furthermore, multiple devices may be pre-authenticated by the group owner for the same group, with different subsets of group members joining from different ones of the devices.

This is illustrated in the FIG. 1 example, where users 121 and 122 are logged in to the system to participate in an activity through end user device 108, whilst users 123, 124 and 125 are logged in through end user device 110. However, users 121-125 are all members of a predefined user group 120. A master user 126 is the owner of the group and may authenticate with the authentication server 104 on behalf of the group via one or both of the end user devices.

Authentication occurs via interaction with the authentication server 104. However, as described in more detail later, certain authentication details may also be cached at the user device to allow some functionality to be provided even when the device is disconnected from the network.

The described approach can be particularly beneficial in a classroom context, especially for younger students, by simplifying the authentication process, whilst also allowing multiple students to share a single tablet device.

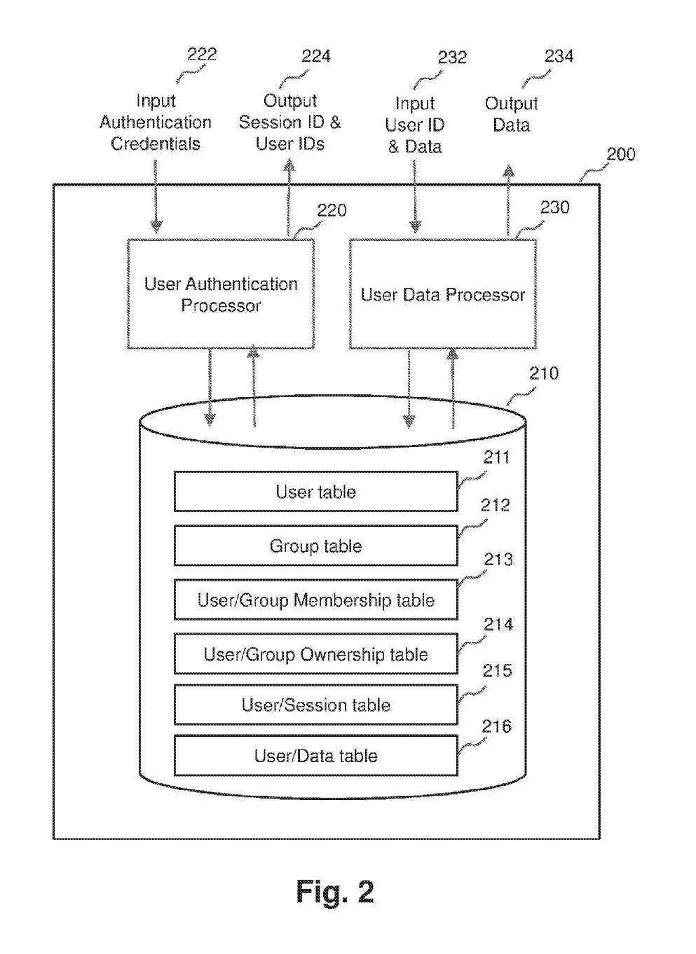

The functions of the authentication server 104, activity server 112 and/or database 102 may be combined in a single server. Such an embodiment is illustrated in FIG. 2.

The server 200 includes a user authentication processor 220 for handling authentication, and a user data processor 230 for processing data relating to activities/games.

The server comprises a database 210 including a user table 211 and group table 212 storing details of users and groups respectively. User/Group membership table 213 stores information identifying which users are members of which groups, whilst user/group ownership table 214 associates each group with its owner(s).

The user authentication processor 220 receives authentication credentials (e.g. username and password) 222 and authenticates a user based on the credentials and the information stored in user table 211 (which may include usernames, hashed passwords and the like). Assuming the user is successfully authenticated, a new user session is created and session information is stored in User/Session table 215. Additionally, information about groups of which the user is an owner and the members of those groups may be supplied to the user in response to authentication, or later on demand. In one example, responsive to a successful authentication, the user authentication processor outputs a response 224 to the user including a session ID for the session and a list of User IDs of a group for which the user is identified as group owner in table 214.

The User Data Processor 230 receives user data 232, which may, for example, include game inputs or game outcomes generated locally at the user device (such as an indication whether a quiz question was answered correctly or not). The user data is associated with a User ID of the user from whom the user data is received.

The user data processor 230 performs any necessary processing and stores the data in user/data table 216, associated with the relevant User ID. User data processor 230 may further generate output data 234 for transmission to the user device, such as game scores, win/loss indications, leader board data, and the like.

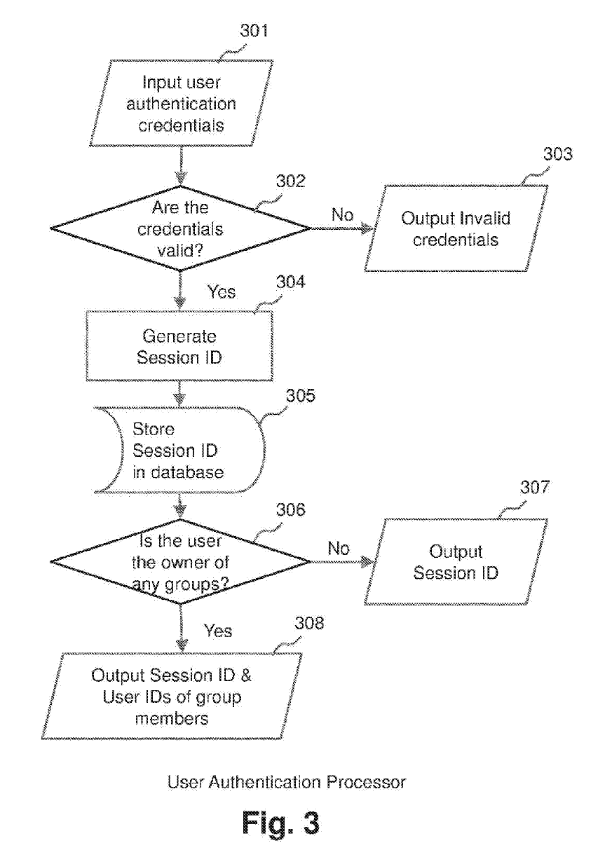

FIG. 3 illustrates in overview a process performed by the User Authentication Processor 220 when authenticating a user.

In step 301, user authentication credentials are received from an end user device, and are checked for validity in step 302. If invalid, the process ends with an error message being returned to the user device in step 303.

If, on the other hand, authentication succeeds (i.e. the credentials match stored credentials), a session ID is generated in step 304, and is stored in the database (e.g. user/session table 215) in step 305. In step 306 the system determines whether the user is the owner of one or more groups. If this is not the case, the system simply returns the generated session ID to the user device in step 307.

If the user is the owner of one or more groups, the user authentication processor outputs the session ID and User IDs of the members of each identified group to the end user device in step 308. In addition to the User IDs, additional information such as a system user name (if different from the user ID), real name, avatar image and/or other user profile information may be sent. The authenticated user thus becomes a master user for a number of sub-users, the sub-users being members of the master user's group(s).

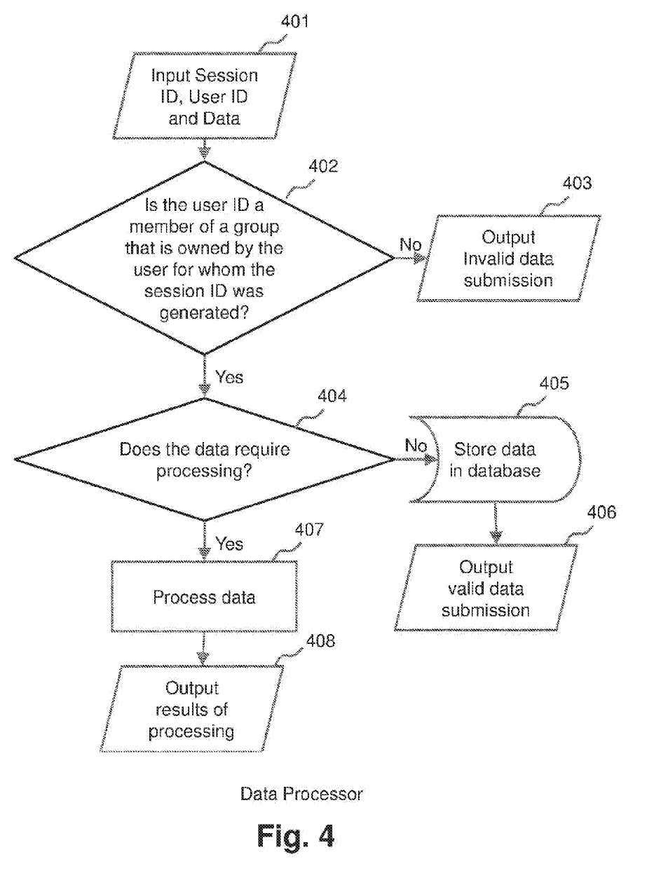

FIG. 4 illustrates in overview a process performed by the User Data Processor when processing user data.

In step 401, the system receives a message from an end user device including a session ID, user ID and user data. Note that the user ID may not correspond to the user who was authenticated with the system in the FIG. 3 process (the master user), but to a member of one of that user's groups (i.e. a sub-user of the master user).

Thus, in step 402, the system determines whether the received user ID corresponds to a member of a group owned by the authenticated user, with the authenticated user being determined from the session ID (since the session ID was generated when the master user was authenticated and is associated with the master user in the user/session table 215).

If the user ID does not correspond to a sub-user of the master user (and session owner), then an error message is output to the device in step 403 indicating that the data submission is invalid.

If the user ID corresponds to a valid sub-user (group member), the system determines (step 404) whether the data requires processing, and if so the information is processed (step 407), with any results being output to the end user device in step 408 (and/or stored in the database as required). If no processing is required the data is simply stored in the database (step 405) and an acknowledgement of a valid data submission is sent to the end user device in step 406. Data stored in the database is associated in the database with the received User ID (corresponding to the user submitting the data).

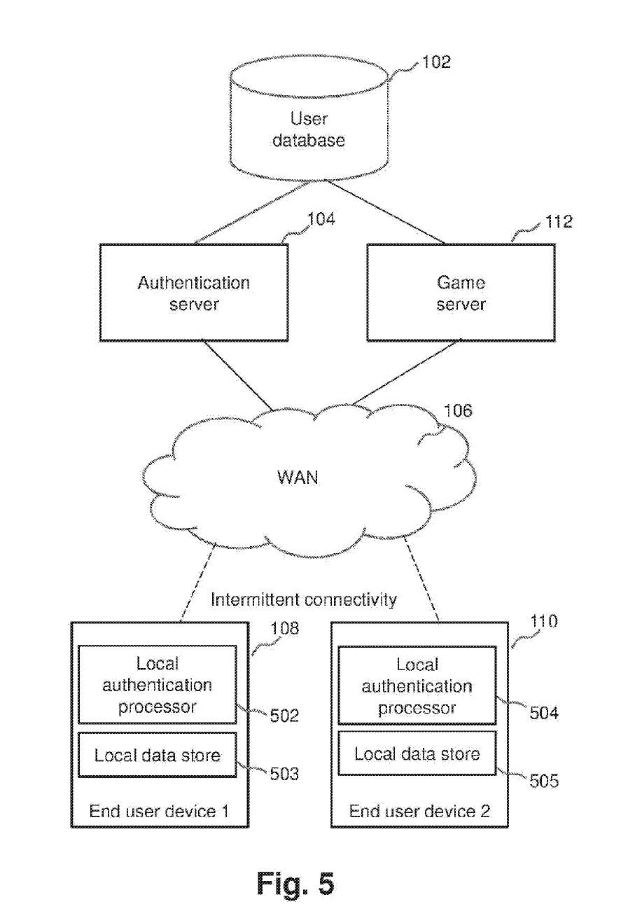

FIG. 5 illustrates a variation of the FIG. 1 system in which the end user devices 108, 110 include respective local authentication processors 502, 504. These may cache authentication credentials, and/or session information for previously authenticated users, and utilise this information to enable local authentication at the device in the case of loss of connectivity. User data generated locally may also be cached in local data stores 503, 505 and transmitted to the server later, when connectivity is re-established.

In FIGS. 1 and 5, the end user devices connect to the server directly via a wide area network (WAN) 106 such as the Internet. Alternatively, the server could be locally connected via a local area network (LAN).

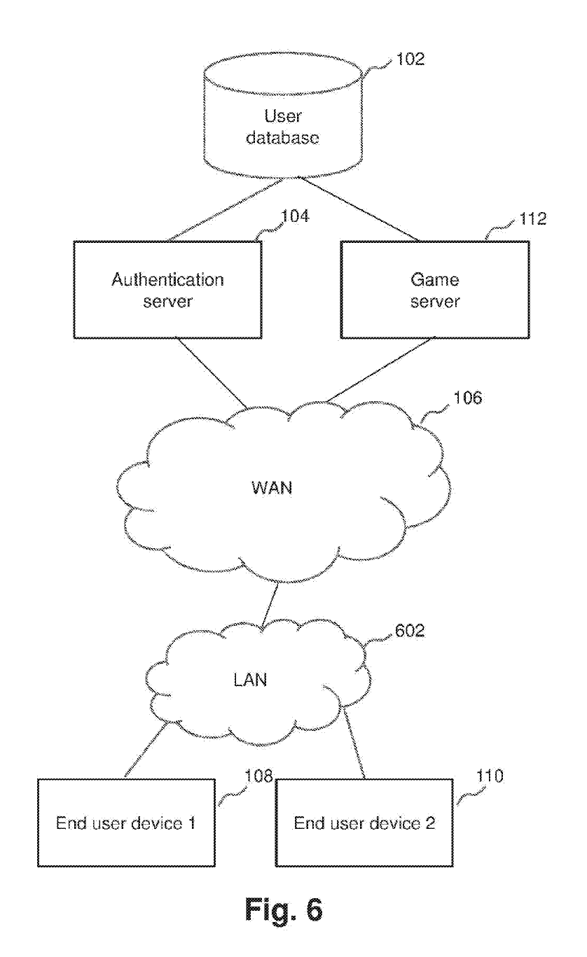

A further configuration is illustrated in FIG. 6, in which the end user devices 108, 110 are connected to the WAN 106 via a LAN 602. Membership of the LAN may be used to make authentication decisions; for example, the system may permit user group members on multiple user devices within the same LAN to join an activity or game without requiring each user device to be authenticated (e.g. requiring the master user/group owner to authenticate on only one of the devices). Membership of the LAN may be determined by a suitable identifier, such as IP address or a Service Set Identifier (SSID) of a wireless LAN.

Operation of the system is described in more detail in the following sections. In the following description it is assumed that the group owner is a class teacher configuring the system for use in a classroom context, and the group members are students participating in educational games. The games take the form of multiple-choice questions (for example relating to mathematics or grammar), with players on each end user device taking it in turns to answer questions and being awarded points based on whether the questions are answered correctly, and based on how quickly correct answers are given.

Setting Up a Device with Multiple Users (Group Login)

The process of enabling a teacher to set up a tablet for use by one or more students in a class is as follows:

1. A login interface is presented to a user on a tablet display
2. A user enters login credentials (username and password)
3. The tablet sends an authentication request to an authentication server including a username and hashed password
4. The server authenticates; if successful the server generates a session ID, stores the session ID in a table associating it with the user ID corresponding to the authenticated user, looks up in a table sub-users associated with the user and sends the session ID and sub-user information in a response back to the tablet
5. The tablet stores the sub-user information on the device for future reference.
6. A user interface is then presented to the user that allows the user to choose whether to log in another user, start a new activity or join an existing activity.
7. The user chooses to start a new activity to do on the tablet. For example the activity may be to answer questions in the twelve times table.
8. A user interface is then presented to the user showing the list of sub-users from the previously stored sub-user information and asking the user to select one or more sub-users to participate in the activity.
9. The user (or individual sub-users) selects sub-users from the list.
10. The list of selected sub-users is stored locally on the device.
11. A user interface is then presented to the user wherein each user from the list of selected users is asked to perform an action in the activity in turn. For example each user may be asked to solve a multiple choice maths question.
12. Each sub-user performs an action in the user interface in turn and the tablet sends an event to the game server, the event including the session ID, a sub-user identifier and data describing the action. For example the data may contain information about the question asked, whether the user answered the question correctly and the time taken for the user to answer the question.
13. The server validates that the sub-user identifier belongs to a user who is a sub-user of the user for whom the session ID was previously generated; if successful the data is stored on the server and associated with the specified sub-user.

In the final step (step 13) where the server stores the user data it is not necessary for the server to validate the sub-user identifier if the server trusts the tablet. The server can trust the tablet if it is known that the tablet will only ever send events that are valid. In practice the server can trust the tablet if the software running on the tablet has been verified to only ever send events that are valid. In this case the server may require the tablet to send an additional identifier identifying the tablet either with the initial authentication request (or alternatively every time an event is sent to the server).

In the system described users who are not group owners (whether or not they are a member of a group) can still have individual authentication credentials and can still log in as an individual. When the authentication system receives the authentication credentials of a user who is not the owner of a group it does not attach any additional user IDs, but still returns a session ID.

The messages sent between the tablet and the server may be sent using a standard network communications protocol such as HTTP. In practice, a secure communication protocol that encrypts the messages, such as HTTPS, is preferably used to provide added security. By using a secure protocol it can be ensured that session IDs remain secret between the server and the tablet.

The users do not necessarily need to perform actions in turn; instead actions could be performed simultaneously as long as each action can be attributed to the right user. For example the user interface may have separate buttons on the screen for each user; the screen may be divided into different areas with each user interacting within a different area; or the users may each use a different peripheral input device, such as a game controller, that connects to the tablet to identify their actions.

This approach allows a single group owner to log into a software application and then lets any member of the groups owned by the group owner to perform actions in the user interface that can be attributed to the correct user, as if that member had logged into the software application explicitly themselves. Such a system may in some respects be less secure than a system where every user has to authenticate themselves individually, but in a trusted group of users and for many applications this level of security is sufficient. For example, in a classroom environment the students may be trusted to select their own names and not the names of other students in the class. Moreover even if a child selects the name of another child (either deliberately or by accident) the system will simply record activity data against the wrong user and that data can easily be deleted from the system or reassigned to the correct user by the teacher later if required.

However, the user interface may enable a user to do many actions on the device as well as participating in an activity. Such actions may include changing the user's displayed name, changing their avatar, changing their password, adding a friend as a connection, sending a message to a friend, reading messages sent by friends to the user, viewing the results of the past activities of the user, viewing the user profiles and results of past activities of other members of the group, viewing the profiles and results of past activities of friends or family of the user and many more actions. In preferred embodiments, many of these actions are only permitted if a user has explicitly individually logged into the application (using appropriate individual authentication credentials) and not if the user has only selected their name from a list of group members following a group owner logging into the device. In some cases restricted actions are hidden in the user interface for users who have not explicitly logged in as individual users. In other cases such actions are shown, but when a user selects one of these actions the user is asked to enter their individual password in order to continue.

In the description above the login user interface and user interface for user selection may be displayed within an individual software application installed on the device and each individual application that uses the system may present these interfaces as part of the application.

Alternatively the user interfaces may be displayed in a central application interface of the device as part of central authentication application or as part of the operating system. As a further variation, the user interfaces may be displayed in one application and other applications may communicate with that application when needed for authentication and user selection purposes. In that case the authentication application (which may be web-based via a web browser) presents the login interface and communicates with the server passing the session ID and other authentication parameters back to the original software application after a successful authentication. The same approach can be applied to user selection.

### Group Login Additional Details

A more detailed version of the process for enabling a teacher to set up one or more tablets so that students can start a new activity without needing to explicitly log in themselves is set out below. This process can allow for authentication even where connectivity to a central server is only intermittently available (see FIG. 5).

1. A login interface is presented to a user on a tablet display
2. A user (e.g. teacher) enters login credentials (username and password)
3. The tablet checks whether it is connected to the Internet and if so the tablet sends an authentication request to an authentication server including a username, hashed password and tablet ID.
4. The server authenticates; if successful the server generates a session ID, stores the session ID in a table associating it with the tablet ID and user ID corresponding to the authenticated user, looks up in a table groups for which that user is an owner, if any, and then sends the session ID, user information and group information, if any, in a response back to the tablet. The group information contains a group identifier and a group name. The user information contains a user identifier, the user's real name and an avatar identifier. It may also contain a list of user information corresponding to users who are friends of the user and other information related to the user.
5. The tablet receives the response and stores all the returned information on the device for future reference by the device.
6. If the tablet is not connected to the Internet in step 3, the tablet checks whether it has previously authenticated a user with that username with the authentication server by testing to see whether it has a session ID stored for that user on the device; if such a session ID exists the tablet checks that the hashed password matches the stored hashed password and if so continues to the next step as if it had received a validated response from the authentication server.
7. The tablet adds the user identifier in the response to a list of logged in users on that device (so that that user can later be selected to participate in activities on that device from an interface that allows users to be selected).
8. If the response does not contain group information the user is then presented with an interface that allows the user to log in another user, start an activity or join an activity. END of AUTHENTICATION STAGE.
9. If the response contains group information, a user interface is presented to the user asking the user whether they want to configure the device for themselves as a user or alternatively configure the device for one of the groups (e.g. school classes) for which they are an owner.
10. If the user chooses to configure the device for themselves the user is then presented with an interface that allows the user to log in another user, start an activity or join an activity. END of AUTHENTICATION STAGE.
11. If the user is the owner of only one group, then the identifier for that group is stored as the current active group (so that sub-users, e.g. students, from that group can later be selected to participate in activities on that device).
12. If the user is the owner of more than one group, then an interface is presented to the user that enables the user to select one of the groups; the identifier for the selected group is then stored as the current active group.
13. The tablet then checks whether it is connected to the Internet and if so the tablet sends a request to the authentication server for the list of sub-users who are members of that group. The request includes the session ID and the group identifier.
14. The authentication server checks that the group identifier is for a group that is owned by the user for whom the session ID was created; if so it looks up in a table the sub-users who are members of that group and returns the sub-user information in a response.
15. The tablet stores the sub-user information for future reference.
16. The user is then presented with an interface that allows the user to log in another user, start an activity or join an activity. END of AUTHENTICATION STAGE.

### Activity Selection and User Selection

Using the above processes, the class teacher can thus authenticate on a tablet or other end user device and configure the tablet for use by students in his class. Subsequently, the device can be set up to participate in an online game or other multi-user activities, with the participating users selected from the pre-authenticated group without requiring full individual authentication.

Activity and user selection may be carried out using the following process.

1. A user interface is presented to the user that enables the user to select a new activity to do on the tablet from a list of activities on the tablet. For example, the activities might include a mathematics quiz, an English grammar quiz and a French quiz.
2. The user selects an activity.
3. The tablet stores an identifier for the activity and generates and stores a unique activity instance identifier that identifies the specific instance of that activity.
4. A user interface is presented to the user asking the user whether they want to allow users on other devices to join the activity.
5. The user selects whether they want to allow other users to join the activity.
6. If the user selects that they do want to allow users on other devices to join the activity, then the user is presented with a user interface that allows the user to choose how they wish to enable other users to join the activity; the interface offers the options for the user to invite individual users directly, to let others join where those users are members of the same group, to let other users join who are using devices on the local wireless network or to let others join by entering a shared secret code.
7. The user selects an option as to how they want to allow others to join the activity.
8. In the following steps, if the tablet is not connected to the Internet the message is stored on the device in a list of pending messages and sent to the server when a connection becomes available.
9. If the user chooses to invite other users directly, the user is presented with a user interface that enables the user to select specific users to invite. The user selects users to invite and the tablet sends a message to the authentication/game server containing the user IDs of the invited users as well as the session ID, activity ID and activity instance ID.
10. If the user chooses to let users join the activity who are members of the same group, the tablet sends a message to the authentication/game server containing the group identifier as well as the session ID, activity ID and activity instance ID.
11. If the user chooses to let users join the activity who are using devices on the same local wireless network, the tablet sends a message to the authentication server containing the identifier of the wireless network (typically the SSID) as well as the session ID, activity ID and activity instance ID.
12. If the user chooses to let users join the activity by sharing a secret code the tablet presents a user interface to the user that displays the secret code and sends a message to the authentication server containing the secret code as well as the session ID, activity ID and activity instance ID.
13. The server stores the activity ID, activity instance ID and the data specifying how others may join the game. If the data specifies that specific users have been invited to join the game, the server sends a push notification to any devices that each of the invited users are known to be logged into at that time. A user interface will be presented to those users on those devices notifying them that they have been invited to join an activity.
14. If the tablet is connected to the Internet, the tablet sends a request to the server to retrieve a list of users who have joined the activity from other devices. The request includes the session ID and activity instance ID.
15. The server looks up in a table users who have joined the activity with the specified activity instance ID and sends the user information to the tablet in a response.
16. A user interface is then presented to the user showing a list of users for selection to participate in the activity on the tablet. If a current active group identifier is stored (as a result of the user choosing to set up the device for a group at the time of authentication) the list of users presented will be the sub-users from that group minus the list of users who have already joined the activity or been selected to join the activity on the device. If a current active group identifier is not stored the list of users presented will be the individually logged in users minus the list of users who have already joined the activity or been selected to join the activity on the device.
17. The user (or individual sub-users themselves) selects a user from the list of sub-users.
18. The tablet adds the user to a list of selected users for the activity on that device
19. A user interface is presented to the user allowing the user to select another user to participate in the activity or to start the activity
20. If the user chooses to select another user the tablet returns to step 14.
21. If the user chooses to start the activity the tablet stores the list of users selected to participate in the activity on the device and sends a message to the server containing the list of users who have been selected to participate in the activity, the message containing the session id, the activity instance ID and a list of user ids.
22. The server stores this list of user ids in the table of users who have joined the game for the specified activity instance identifier.
23. A user interface is then presented to the user wherein each user from the list of selected users is asked to perform an action in the activity in turn. For example each user may be asked to solve a multiple choice maths question.
24. Each user performs an action in the user interface in turn and the tablet sends an event to the game server, the event including the session ID, a user ID and data describing the action. For example the data may contain information about the question asked, whether the user answered the question correctly and the time taken for the user to answer the question.
25. The server validates that the sub-user identifier belongs to a user who is a sub-user of the user for whom the session ID was previously generated (i.e. the user is member of a group pre-authenticated by its owner); if successful the data is stored on the server and associated with the specified sub-user.

The response to the initial request to authenticate can also contain the sub-user information for all groups for which the user is an owner and if so there is no need for a subsequent request to get the sub-user information. If the user is the owner of only a few groups it may be more efficient to return the sub-user information at the same time as authenticating. If the user is the owner of many groups or several large groups it may be more efficient to only get the sub-user information once the user has selected a specific group. Note that the term “sub-user” refers to a member of a group.

The system described above assumes all tablets communicate with a central server. If the tablets are disconnected from the Internet, then the user is still able to log into the software application and enable group members to select their names as long as the user has logged into the software application previously. The login credentials, session ID and user information of members of the group are stored locally on the device after a successful login for this purpose. Similarly if the tablets are disconnected from the Internet, instead of sending a message to the server when each user performs an action, the data describing each action is stored on the device and sent to the server when an Internet connection becomes available.

When no connection with the Internet is available the devices may still communicate with each other either by direct peer to peer connections or through a local network that has no outside connectivity. In this case the devices send messages directly between each other or one of the devices may configure itself as a local server through which device communications are routed.

Some of the steps can be performed asynchronously. For example connecting to the server to get a list of users who have joined an activity can be performed at the same time as allowing users to select their names in the user interface instead of in sequence. In this way the user interface can be updated in real time as other users join the activity. Moreover, rather than the tablet sending a request to the server to get a list of users who have joined the game already, the server may send a message to the tablet whenever it receives a message from another tablet containing a list of new users who have joined the game. Such a message can be sent using push technology such as that provided by full duplex websockets or by long polling over HTTP.

The UI for selecting users may or may not contain the user who logged in explicitly. For example a teacher may log into a software application and the list of users that can be selected to perform activities in the application may only contain the list of students in the class and not include the teacher. In this case the teacher user is the group owner but not a member of the group. In another example, a parent may log into a software application and the list of users that can be selected to perform activities in the application may include all members of the family including the parent who logged in explicitly. In this example, the parent is both a member and owner of the group. A group may have multiple owners and all members of a group can also be owners of the group such that any member of the group can log in to the application with their own credentials and enable other members of the group to select their name and start an activity.

The user interface for selecting users may be shown multiple times and each time a different set of users may be selected to perform activities in the software application without the original logged in user needing to login again. For example, the activity might be a short ten minute game and after one set of users in the group have finished playing that game, they may pass the device to another set of users in the group.

When a user who is a group owner logs into the software application the user is presented with an option as to whether the user should configure the application for use by himself or for use by one of the groups for which he is an owner. If the former option is selected, the interface for selecting users will display the list of all explicitly logged in users. If the latter option is selected, the interface will display the list of all the members of the selected group. If more than one user is explicitly logged in then the option chosen by a current “gamemaster” is used. If more than one logged in user has chosen to configure the device for use by a group then the interface for selecting users will contain the members of the group selected by the current gamemaster. By default the last user to log in is set to be the gamemaster. For example several different teachers may share a set of tablets and use the tablets in their classes and each teacher may log in to the device separately selecting a group.

When a user who is an owner of multiple groups logs into the software application and the user chooses to configure the application for use by a group the user interface displays an option to select the groups to be used. For example, a teacher may have multiple classes and will typically want to set up the software application for one class at a time.

A logged in user who is not the current gamemaster can become the gamemaster (and so reconfigure the application to the state that they had previously selected when authenticating) by selecting their name in a user interface that presents a list of logged in users (this user interface is distinct from the user interface used to select users to participate in an activity). When a logged in user who is not the current gamemaster chooses to become a gamemaster, the user can optionally be giving the choice to configure the application for himself or for one of the groups for which he is an owner again. For added security the user may optionally be asked to reenter their password when configuring the application for use by one of the groups for which he is an owner.

The current gamemaster may want to change the group that they selected to a different group for which they are an owner. A user interface is presented to the user that allows them to make this change. For added security the user may optionally be asked to reenter their password when making this change.

### Joining an Activity

The process of enabling students to join an activity from another tablet without needing to explicitly log in is as follows:

1. The tablet makes a request to the server for a list of available activities to join; the request containing the wireless network identifier (if present), the group identifier (if the device has a current active group) or the user identifier (if the device does not have a current active group) and the tablet identifier.
2. The server looks up in a table activities that match the wireless network identifier, the group identifier or the user identifier and that have been specified to allow users on other devices to join the activity and sends the activity information associated with those activities in a response to the tablet. The activity information contains an activity instance identifier, the activity identifier and the group identifier (if present).
3. A user interface is presented to the user that lists the available activities to join and enables the user to select one of the activities returned by the server or alternatively to enter the activity code of an unlisted activity in an entry field.
4. If the user enters the activity code of an unlisted activity in the entry field, the tablet sends a request to the server for the activity information for that activity.
5. The server looks up in a table the activity information corresponding to the activity code and if present sends the activity information to the tablet.
6. If the user selects an activity from those listed or when the tablet receives the activity information for the activity corresponding to the activity code then, if the activity information for the activity contains a group identifier the tablet makes a request to the server for the user information of users who are a member of that group, the request containing the group identifier and the activity instance identifier.
7. The server validates that the activity instance identifier and group identifier are consistent; if so the server looks up in a table the user information for the group and sends the user information to the tablet in a response.
8. If the tablet is connected to the Internet, the tablet sends a request to the server to retrieve a list of users who have joined the activity from other devices. The request includes the session ID and activity instance ID.
9. The server looks up in a table users who have joined the activity with the specified activity instance ID and sends the user information to the tablet in a response.
10. A user interface is presented to the user displaying a list of users that can be selected to participate in an activity. The list of users will either be the list of users logged into the application (if the activity information contains no group identifier) or the list of users who are members of the group (if the activity information does contain a group identifier).

In the initial request the wireless network identifier will only be present if the tablet is connected to a wireless network and the group identifier will only be present if the user who logged in to the application chose to set up the application for use by a group. As such wireless activities will be returned if the activity was created on a tablet on the same wireless network and group activities will be returned if a user who owns that group has logged in.

The above process lets a teacher log in to just one tablet and then students on any other tablet on the same wireless network can join the activity by selecting the activity and selecting their names from a list. This can be more efficient than having all the students log into the software application with their own individual login credentials.

Where a teacher has logged into all the devices the students can similarly join the activity by selecting the activity and selecting their names from a list. This option is useful when all the devices are not on the same wireless network (when, for example, some or all of the devices are connected to the Internet via a 3G network and no local network identifier is available).

When the students are geographically dispersed, the devices will not be on the same wireless network and the teacher may not be able to log into each device. In this case the teacher can allow students on other devices to join the activity be entering an activity code into the user interface, with the activity details (e.g. including associated group ID and user IDs of group members) being retrieved based on the activity code.

When users join a game based on the wireless network ID, or by entering an activity code, one benefit is that the devices can be automatically set up to display a list of users from the class without the teacher having to explicitly log into each device as discussed before. Another benefit is that all the actions are recorded on the server with the same activity instance ID and as such the actions can be processed as actions belonging to the same instance of the activity.

### Using a Group PIN

In a further variation, a process is implemented that enables students to create a new activity on a device without requiring the teacher to log into the device each time, by using a special group authentication code distributed to the students by the teacher. The authentication code is referred to here as the group PIN, though any form of numerical or alphanumerical password or passcode may be used.

The process for configuring a group PIN is as follows:

1. A logged in user sets up a group for which they are an owner on a device (as discussed previously).
2. If this is the first time the user has set up the device for that group, a user interface is presented to the user asking if the user would like to enable a group PIN for this device.
3. The user chooses to enable a group PIN for this device
4. The tablet sends a request to the server requesting the group PIN, the request containing the session ID and the group identifier.
5. The server verifies the session ID is consistent with the group identifier and if so looks up in a table the hashed group PIN for the group and sends a response to the tablet, the response containing the hashed group PIN if present.
6. If the server responds with a hashed group PIN the tablet stores the hashed group PIN in a local table, associating it with the group identifier
7. If the server responds without a hashed group PIN, a user interface is presented to the user asking the user to enter a group PIN in an entry field.
8. The user enters a group PIN.
9. The tablet stores the hashed group PIN in a local table associating it with the group identifier and sends a message to the server containing the session ID, the group identifier and the hashed group PIN.
10. The server verifies the session ID is consistent with the group identifier and stores the hashed group PIN in a table associating it with the group identifier and tablet identifier.

The user subsequently logs out of the tablet.

The process for logging in using a group PIN is as follows:

1. A login interface is presented to the user on a tablet display, the login interface containing an option to log in by entering a PIN as well as the option to log in by entering a username and password.
2. The user enters a PIN.
3. If the tablet is connected to the Internet, the tablet sends a request to the server to validate the PIN; the request containing the hashed PIN and the tablet identifier.
4. The server verifies that the hashed PIN is consistent with the tablet identifier and looks up in a table the group identifier associated with the hashed PIN and tablet identifier and, if it exists, sends the group identifier in a response to the tablet.
5. The tablet stores the hashed PIN in a local table with the associated group identifier and sets the group identifier as the current active group.
6. If the tablet is not connected to the Internet, the tablet looks up in a local table the group identifier associated with the hashed PIN and sets the associated group identifier as the current active group.

Subsequently, a list of the group members is obtained and displayed as described previously, allowing group members to be selected for participating in a game or other activity.

With this process a teacher can create a PIN and share it verbally with the class. As long as the teacher has previously logged into the tablet, then any student in the class can set up the tablet for the class by entering the PIN and enable students in the class to participate in an activity be selecting their names from a list of students.

In the above description the PIN is created the first time a teacher configures each tablet for a class. However, the teacher may set up the PIN before this point, for example, at the time that the teacher creates the class list in the first place, or after this, for example, when the teacher decides that it would be useful to start using a class PIN.

In the above description the teacher is asked whether they want to enable the PIN for a class at the time they first configure a tablet for a specific class. However, the software application may alternatively automatically set itself up with the hashed PIN for that class without asking the teacher at this point. Moreover, the software application may be set up with the hashed PINs for all the teacher's classes at the point that the teacher logs in and this can be done either by presenting the teacher with an interface asking the teacher whether this should happen or automatically without asking.

Note that instead of enabling a teacher to create a class PIN, the application could enable a teacher to create class login credentials that are shared with the class. These class login credentials would have the same effect as logging in with the teacher's credentials (except the option to set up the application for the teacher would not be offered and the software application would be configured for class use). Logging in with a class PIN is simpler, but preferably requires the teacher to have logged into that device at least once previously, whereas logging in with class credentials would not necessarily require the teacher to have logged into that device before. Using a class PIN is however quicker and easier for students to remember and the preferred implementation.

### Further Optional Features

In the processes described above, a teacher can log into all end user devices, or alternatively a teacher can log into one device, start a game, and choose to let other users on other end user devices join that game through being on the same wireless network or by entering a game code. In the latter cases (if the teacher has not already logged into the other devices explicitly), the other devices are set up with the class list at the point at which students join a shared game.

Alternatively, the devices could be set up with the class list before joining the game. In this approach, an administrator or the teacher may log into the software application on each tablet and register the tablet with the server. A teacher can then automatically set up any of those tablets with the class list by logging into one of the tablets (or logging into a web interface on a PC) and asking at that point for all those devices to be set up for the class, e.g. by clicking a button (effectively performing a remote class log in automatically across all devices). Similarly the teacher could log out of all devices remotely, so clearing the list of students who can be selected to use that device.

A school might have many tablets in use at the same time in different classes, so the user interface preferably allows the teacher to select some subset of the devices instead of selecting all devices. Alternatively the teacher might set up a temporary PIN and communicate it to the class to restrict the class set up to the subset of devices actually in the classroom.

Alternatively a teacher could set up all of the tablets in the classroom with a class list by logging into one tablet and specifying that all tablets connected to the same wireless network should automatically be set up with the class list for a specific class. The other devices could then automatically test whether they are on the same wireless network as a device that has recently been set up for class use and if so provision the device with the members of that class. For added security or to limit the class list setup to only those devices in the classroom in a school that has a school wide wireless network and many devices in use in different classrooms, the teacher might set up a temporary PIN and communicate it to the class. This has an advantage over the previous method in that it does not require the tablets to be registered with the system before they can be used.

To improve security, a mechanism may be provided for group members to set a flag for each group they are a member of to say a) whether or not they should appear on the list for selection when that group is provisioned and b) if they do appear on the list for selection, whether or not they need to enter their password when selected.

Though in the described examples, group owners are typically teachers, in principle any user can create a group. For example, the system may allow students to great groups among their friends, or parents to create groups for their families.

Groups may also have sub-groups defined for them, where a sub-group comprises a subset of members of the group. Multiple overlapping or non-overlapping sub-groups may be defined. Sub-groups may then be displayed in addition to, or instead of, individual user names in the user selection interface. Selection of a sub-group results in all members of that sub-group being registered to participate in the game or activity.

For example, a teacher can create groups within her class, perhaps around different levels of ability, and instead of selecting their individual names from a list, the students select their group from the list. Selecting the group would have the same effect as if the students in that group selected their names individually from a list of all the students in the class and all the students take their turns in the game as described previously with data recorded against each student individually.

In a further variation of this multiple students on one end user device may be performing the activity as a group and not as individual users and so the activity data is recorded against a (sub-)group ID as well as or instead of against their individual user IDs.

The described approaches to authentication and device setup allow end user devices to be set up with a class list so that students can participate in an activity simply by selecting their name from the list without individual authentication. Authentication is performed on a group level by the teacher. Furthermore, multiple students may participate in an activity on a single device at the same time.

In addition to management of games, the game server 112/combined server 200 may additionally provide analytics functionality. This may allow the teacher to conduct analysis functions such as analysing performance of students individually or in groups, displaying performance statistics, assessing learning improvement based on measured performance, and the like. Parents may also be given access to the data to view their children's performance.

Embodiments of the invention may provide a system/method for authentication and data recording, comprising storing a list of user identifiers in a database; storing a list of group identifiers in a database; storing a first list of associations between user identifiers and group identifiers in a database each association indicating that the user is a member of a group; storing a second list of associations between user identifiers and group identifiers in a database each association indicating that the user is an owner of a group; storing a list of associations between user identifiers, usernames, passwords and real names for each user that is the owner of a group in a database; providing a first processing unit that receives a username and password for a user, processes the username and password of the user to test first whether the username and password are correct and test second whether the user is an owner of one or more groups and if both tests are passed, creates a new unique session identifier, stores the session identifier in a database and associates it with the user's identifier and outputs the session identifier along with a list of the user identifiers and associated real names corresponding to members of the groups for which the validated user is an owner; and providing a second processing unit that receives a session identifier, a user identifier and some arbitrary data, (optionally tests whether the user identifier corresponds to a user who is a member of a group owned by the user associated with the session identifier or is the user associated with the session identifier itself and if the test is passed) then either stores that data in a database and associates that data with that user identifier or performs some further processing action identified by the data and user identifier.

Testing whether the user identifier corresponds to a user who is a member of a group owned by the user may not be necessary if the user device sending the data is trusted to send valid events.

Embodiments of the invention may further provide a method of providing a user interface for authenticating a user, selecting users to participate in an activity and recording actions taken by each user participating in the activity, comprising: providing entry fields for a user to enter a username and password; sending the username and password to a system for authentication; receiving a response from the system for authentication said response containing a session identifier and a list of user identifiers with associated real names; storing the session identifier; displaying the real names in the user interface so that users can select their names; associating data with the user identifier of a selected user as each selected user subsequently performs actions in the user interface the data representing the action; and sending that data to the system for authentication along with the associated user identifier and session identifier.

The Systems and Processes Described Throughout this Description May Provide One or More of the Following Features and Advantages:
1. Enabling a teacher to provision one or more tablets for use by one or more students in a class efficiently:
   One device class provision: Enabling a teacher to provision a tablet for use by one or more students in a class by logging into the device and provisioning it for a class such that students can select themselves from a list of students in the class instead of having to log in explicitly themselves.
   Multiple device class provision, through sharing the same local wireless network: Enabling a teacher to provision multiple tablets for use by a whole class of students by the teacher logging into one device, creating a new game and choosing to permit users on other tablets to join that game if they are on the same wireless network, such that when the users on other tablets join the game (by clicking on one of a list of available local wireless network activities) the students can simply select themselves from a list of students in the class instead of having to log in explicitly themselves.
   Multiple device class provision, through sharing a secret game code: Enabling a teacher to provision multiple tablets for user by a whole class of students by the teacher logging into one device or a desktop PC, creating a new game and choosing to permit users on other tablets to join that game by sharing a game code, such that when the users on other tablets join the game (by entering the game code into an entry field) the students can simply select themselves from a list of students in the class instead of having to log in explicitly themselves.
   Multiple device class provision through a class PIN: Enabling a teacher to provision one or more tablets for use by a class, by creating a class PIN that can be shared with the class and that allows any member of the class to log into a device and provision it for that class as long as the teacher has previously logged into that device.
   Multiple device class provision through a class username and password: Enabling a teacher to provision one or more tablets for use by a class, by creating a class username and password that can be shared with the class and that allows any member of the class to log into a device and provision it for that class.
   Multiple device class provision, through approved tablets: Enabling a teacher to provision multiple tablets for use by a whole class of students by the teacher logging into one device or a desktop PC and choosing to permit users on other tablets to create new games or join class games by approving specific known tablets to be provisioned remotely (effectively performing an automatic remote log in to each device).
2. Removing members of a class who have already joined a game on another device from the list of class members who can join the game on a new device (essentially filtering the class list).
3. Having different features available in the app to users (essentially different levels of use permissions) depending on whether they are a) not logged in, b) are individually logged in or c) have selected their name from a class list after a teacher has logged in (i.e. as selected members of a pre-authenticated group).
4. Caching the authentication details and class lists on the device so that a teacher can log in and provision a tablet and set it up with the class list when disconnected from the Internet
5. Presenting the user with an option to log in as themselves only or log in and provision the device for their class at the point that they log in.

### Server and Client Device Details

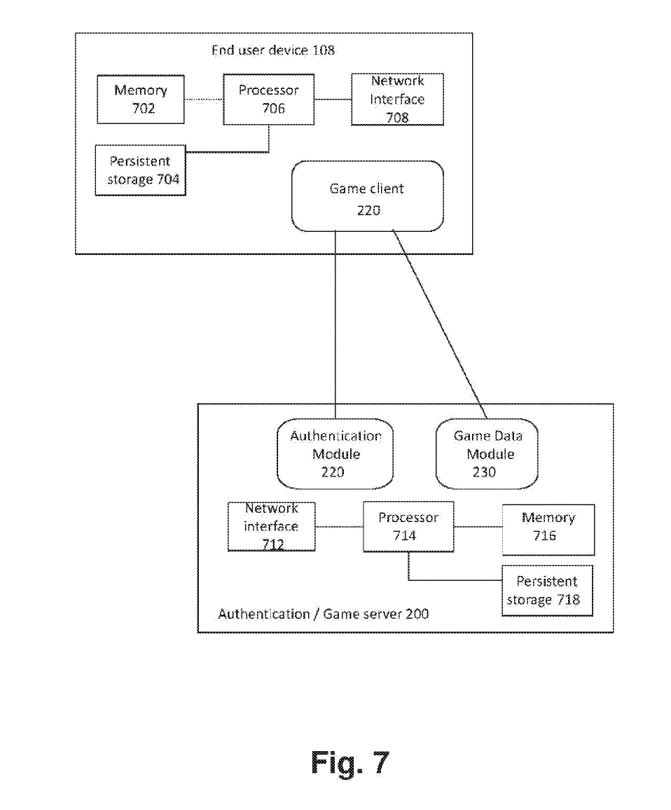

Details of the server and client devices are illustrated in FIG. 7.

The end user device 108 may comprise a tablet computer, smartphone, laptop PC or other form of personal computing device. It comprises a memory 702 and persistent storage media 704 (e.g. FLASH memory or hard disk drive etc.), both for storing computer-executable software code and data, a processor 706 for executing software and a network interface 708 (e.g. WiFi) for communication with external networks such as the Internet. The processor runs a game client application 220, for participating in multi-user activities and games. The game client could be in the form of a web browser displaying a web page/web application, or a standalone application.

The authentication/game server 200 may comprise conventional server hardware and provides the authentication, game management and analytics functionality. Specifically, the server 200 comprises a memory 716 and persistent storage media 718, both for storing computer-executable software code and data, a processor 714 for executing software and a network interface 712 for communication with external networks such as the Internet.

The processor runs authentication software module 220 via which the end user device can be authenticated as previously described, and game data module 230 for receiving, processing and outputting game data and implementing any necessary backend game functionality and processing. User data, authentication data, and game data are stored in memory 716 and/or persistent storage 718. Though a single server device is shown, the functionality of the server 200 may be distributed over multiple servers, for example by splitting authentication, game management and/or analytics functionality in any appropriate manner.

The various methods, user interfaces and software elements described throughout this description are preferably provided in the form of computer-executable software code embodied in one or more tangible computer-readable storage media that may be executed by end user device 108 and/or server 200 or other devices. Though described herein with functionality divided in a certain manner, functionality may be distributed between the client and server devices 108, 200 and/or other components in any appropriate manner or could be implemented in a single device.

It will be understood that the present invention has been described above purely by way of example, and modification of detail can be made within the scope of the invention.

For example, whilst described in relation to educational games in a classroom environment, the invention could have application in other contexts, such as within a home environment where there are multiple devices in the home. For example, a home might have two PCs, a laptop, three tablets and a smart TV. A parent could create an account on one device, create users for the rest of his family as belonging to his group and then log into the other devices whereby, as a result, the other devices automatically have a list of the members of the family to select for logging in (with or without password).

More generally, the invention may be applied to any other multi-user computing contexts requiring user authentication, and may be particularly suitable in contexts requiring shared use of computing devices by a group of users.

1. A method of authenticating users in a software system, the method comprising:
receiving authentication information; and
performing an authentication based on the received authentication information;
the method further comprising, in response to successful authentication:
identifying a user group associated with the authentication information, the user group comprising a plurality of users;
transmitting user identifiers for the group users to a first client device;
receiving a selection of one or more of the group users from the first client device; and
registering the one or more selected group users as active users within the software system.

2. A method according to claim 1, wherein the authentication information is associated with a first user, and wherein the authentication comprises authenticating the first user based on the authentication information.

3. A method according to claim 2, comprising, responsive to successful authentication of the first user, accessing stored information defining a plurality of user groups and group owners associated with user groups; and identifying a user group for which the first user is specified as group owner in the stored information.

4. A method according to claim 1, wherein the authentication information is group authentication information associated with the user group.

5. A method according to claim 1, wherein the one or more selected group users are registered as active users without individual authentication of the one or more group users.

6. A method according to claim 1, wherein the authentication information is received from the first client device.

7. A method according to claim 1, wherein the registering step comprises setting an authentication status of a selected group user to indicate that the user may access one or more software functions in the software system.

8. A method according to claim 1, wherein the registering step comprises assigning a first authentication level to a selected group user, wherein the first authentication level is different from a second authentication level assigned to a user performing individual authentication by submitting authentication information.

9. A method according to claim 8, wherein the authentication information is associated with a first user, the method comprising, in response to successful authentication of the first user, assigning the second authentication level to the first user.

10. A method according to claim 8, comprising providing differential access to software functions in the software system and/or at client devices in dependence on users' respective authentication levels, wherein the first authentication level is more restricted than the second authentication level.

11. A method according to claim 8, comprising, in response to receiving a request to access a restricted software function from a given user authenticated as a group user and/or having the first authentication level, sending a request for authentication information to the given user, and preferably providing access to the restricted software function and/or assigning the second authentication level to the given user in response to receiving and successfully authenticating the authentication information from the given user.

12. A method according to claim 1, wherein the transmitting step comprises transmitting user identifiers for group users to a plurality of client devices; and wherein the receiving step comprises receiving the selection of one or more of the group users from one or more of the plurality of client devices.

13. (canceled)

14. A method according to claim 1, comprising receiving information identifying a multi-user activity from the first client device; the registering step comprising registering the one or more selected users as participants in the identified multi-user activity.

15. A method according to claim 1, comprising:
receiving, from a second client device, a request to participate in a multi-user activity;
determining whether to grant access to users at the second client device to participate in the multi-user activity; and
in the event of a positive determination, transmitting a list of group users of the user group to the second client device;
wherein the list transmitted to the second client device excludes group users already registered as participants in the multi-user activity.

16. (canceled)

17. A method according to claim 15, comprising receiving a selection of one or more group users from the second client device, and registering the selected users as participants in the multi-user activity.

18. A method according to claim 15, wherein the second client device is not currently authenticated or not associated with a currently authenticated user.

19. A method according to claim 15, comprising identifying a network, preferably a local area network (LAN) or wireless LAN, associated with the multi-user activity, wherein the determination whether to grant access is performed in dependence on whether the second client device is connected to the identified network.

20. A method according to claim 15, wherein the authentication information is received from, or the multi-user activity was created at, the first client device, and wherein the determination whether to grant access is performed in dependence on whether the second client device is connected to the same network as the first client device, preferably the same LAN or the same wireless LAN.

21. A method according to claim 15, wherein the request comprises an activity code corresponding to the multi-user activity, and wherein the determining step comprises accessing stored activity information defining one or more previously configured multi-user activities, searching the stored activity information to determine whether the activity code matches a previously configured activity, and granting access to the multi-user activity matching the activity code if a match is identified.

22. A method according to claim 15, wherein the determination whether to grant access is made in dependence on an identity of the second client device, wherein access is granted if a device identifier of the second client device matches one of a preconfigured set of authorised devices.

23. A method according to claim 14, comprising:
receiving activity data relating to the multi-user activity from a client device, the activity data associated with a user identifier;
determining whether the user identifier corresponds to one of the registered users for the activity; and
processing and/or storing the activity data in response to a positive determination, or
outputting an error message in response to a negative determination.

24. (canceled)

25. (canceled)

26. (canceled)

27. (canceled)

28. A method of authenticating users at a client device for access to a software service, the method comprising:
receiving user input comprising authentication information; and
performing an authentication based on the authentication information;
the method further comprising, if authentication was successful:
obtaining user group information, the user group information specifying a user group including a plurality of users;
outputting a list of users of the group to a user interface;
receiving user input indicating a selection of one or more of the group users; and
registering the one or more selected group users as active users of the software service.

29. A method according to claim 28, wherein the step of performing an authentication comprises transmitting the authentication information to the software service; and receiving an authentication response from the software service; wherein the user group information is received from the software service following a successful authentication.

30. A method according to claim 28, comprising determining whether a connection to a network is available; and, if a connection is not available, performing the authentication based on authentication data cached at the client device responsive to a previously performed authentication and/or obtaining the user group information from locally cached user group information.

31. (canceled)

32. A method according to claim 28, comprising running at the client device a multi-user activity module for participating in multi-user activities, the registering step comprising registering the one or more selected group users as participants in a multi-user activity.

33. A method according to claim 32, comprising providing at the client device a user interface for participation by the one or more selected group users in the multi-user activity, wherein the user interface is arranged for turn-based participation by the users and/or wherein the user interface comprises respective separate user interface elements or regions for interaction by each of the selected group users.

34. A method according to claim 32, comprising generating activity data in response to inputs received from the one or more selected group users relating to the multi-user activity, and transmitting the activity data to the software service; the transmitting comprising, in response to detecting that a network connection is not available, caching the activity data at the client device at a first time, and transmitting the activity data at a second time when a network connection is available.

35. (canceled)

36. (canceled)

37. (canceled)

38. A method according to claim 28, comprising caching authentication information and/or user group information at the client device in response to a successful authentication.

39. (canceled)

40. (canceled)

41. (canceled)

42. (canceled)

43. (canceled)

44. (canceled)

45. A non-transitory computer-readable medium comprising software code adapted, when executed on a data processing apparatus, to perform a method of registering users in a software system for participation in a multi-user activity, the method comprising:
receiving authentication information for a first user from a client device; and
authenticating the first user based on the authentication information;
the method further comprising, in response to successful authentication of the first user;
identifying a use group associated with the first user the user group comprising a plurality of further users;
transmitting user identifiers for the further users to the client device;
receiving a selection of one or more of the further users from the client device; and
registering the one or more selected further users within the software system as participants in the multi-user activity.
